(19) United States
(12) Patent Application Publication
(10) Pub. No.: US 2006/0256547 A1
(43) Pub. Date: Nov. 16, 2006

(54) Auxiliary illumination for hand tools

(75) Inventor: Tony Huang, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: HIEVER CO. LTD., Taichung City (TW)

(21) Appl. No.: 11/169,752

(22) Filed: Jun. 30, 2005

(30) Foreign Application Priority Data
May 16, 2005 (TW) 94207902

(51) Int. Cl. B25B 23/18

(52) U.S. Cl. 362/119

(57) ABSTRACT

An auxiliary illumination for hand tools comprises a clip assembly for clip present invention on a hand tool has a clip area. The clip area has a clip member therein. An illumination member with a shell body pivots on the clip assembly. By the way, the illumination member can be rotated opposite to the clip assembly. One end of the illumination member has a light and a battery room inside the shell body.

### BACKGROUND OF THE INVENTION

1. Field of the Invention

The present invention relates generally to an auxiliary illumination, and more particularly to an auxiliary illumination for hand tools.

2. Description of the Related Art

We always need illumination to help when doing a repairing job. The illumination is always not sufficient in the work area especially when we use hand tools. Sometime the light will be shaded from the operator or some objects. It is difficult for an operator to do a repairing jog under the dark area and this is the reason why we need an auxiliary illumination to help.

### SUMMARY OF THE INVENTION

The primary objective of the present invention is to provide an auxiliary illumination, which is easy to use and improve the illumination for the hand tools user also.

According to the objective of the present invention, an auxiliary illumination for hand tools comprises a clip assembly having a clip area therein for clip the auxiliary illumination on a hand tool. An illumination member pivots on the clip assembly.

### BRIEF DESCRIPTION OF THE DRAWINGS

FIG. 1 is an explosion view of a first preferred embodiment of the present invention.

FIG. 2 is an isometric view showing the first embodiment of present invention clipping on a hand tool.

FIG. 3 is a side view of FIG. 2.

FIG. 4 is an isometric view showing the rotated of the illumination member of the first embodiment of present invention.

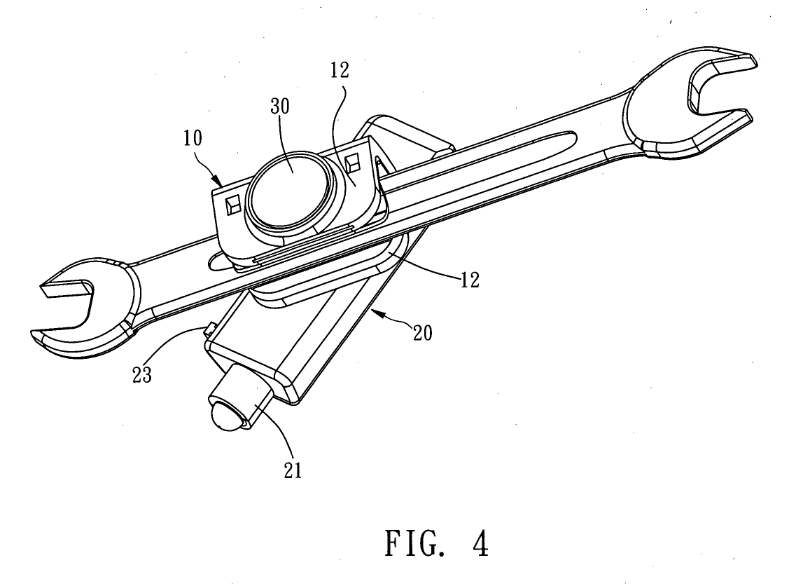

FIG. 5 is an isometric view of the second preferred embodiment of the present invention.

FIG. 6 is a side view showing the second embodiment of present invention clipping on a hand tool.

FIG. 7 is an isometric view showing the rotated of the illumination member of the second embodiment of present invention.

FIG. 8 is an isometric view showing the clip assembly of the third embodiment of present invention.

FIG. 9 is a side view of FIG. 8.

FIG. 10 is an isometric view showing the third embodiment of present invention clipping on a screwdriver.

### DETAILED DESCRIPTION OF THE INVENTION

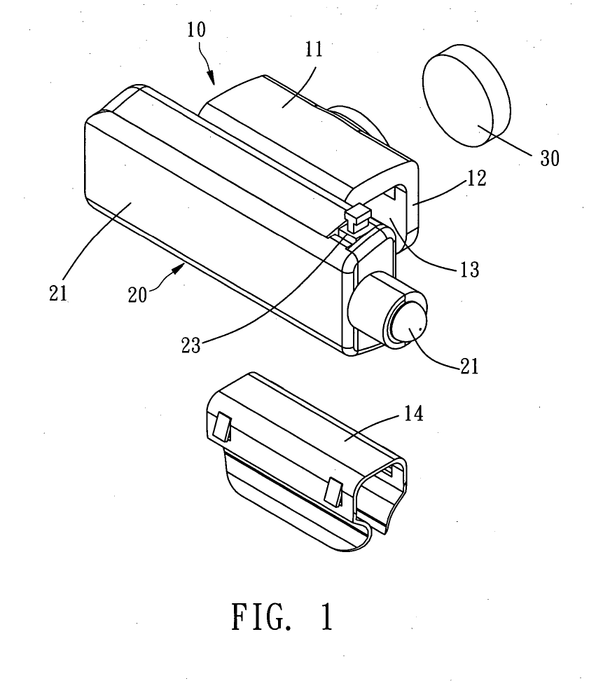

As showing in FIG. 1 to FIG. 3, the auxiliary illumination for hand tools comprising:

A clip assembly 10 for clip present invention on a hand tool like screwdriver, socket wrench or wrench has a board portion 11. The board portion has two fixed stand wall at opposite side. There is a clip area 13 between these two stand walls. The clip area has a clip member 14 therein. The clip member can be a spring, an elasticity board or an elastomer. The clip member is an elasticity clip board in this embodiment of present invention located in the clip area for clipping present invention on a hand tool like wrench.

An illumination member 20 with a shell body pivots on the stand wall of the clip assembly. By the way, the illumination member can be rotated opposite to the clip assembly.

One end of the illumination member has a light 21 and a battery room 22 inside the shell body. The light can be a normal light or LED light. The illumination member also has a switch 23 to control the light.

A magnet 30 locates on the clip assembly. The magnet locates on the stand wall in this embodiment.

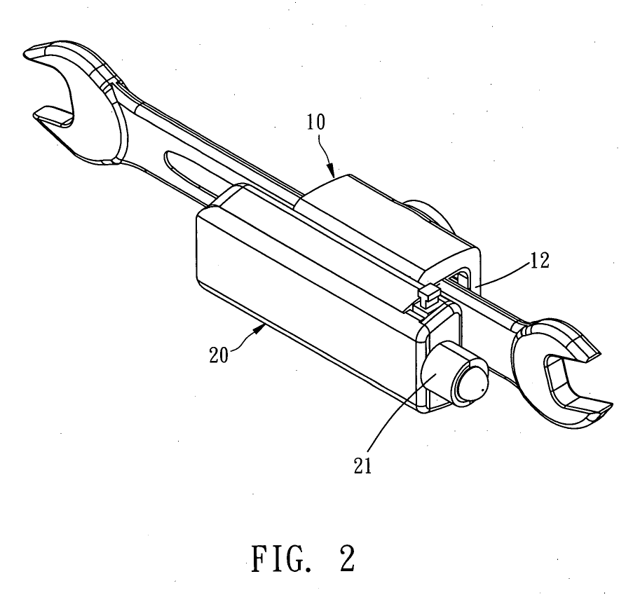

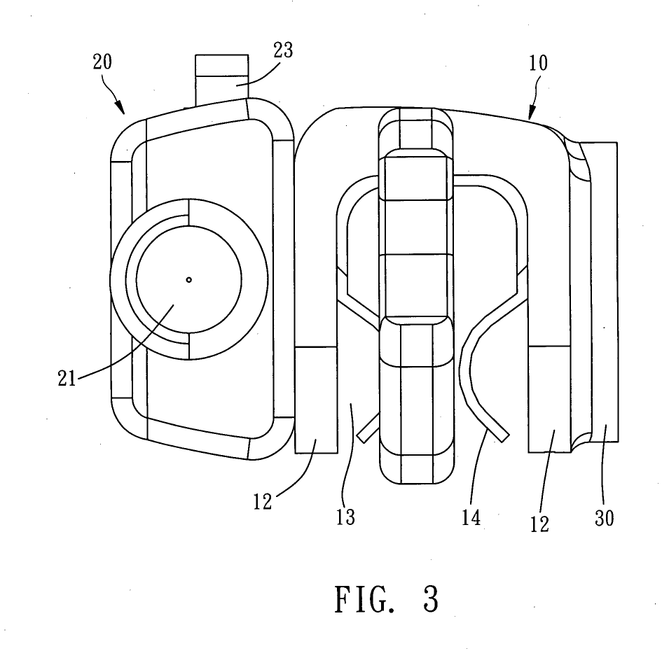

The first embodiment of present invention can be direct clipped on a hand tool like screwdriver, socket wrench or wrench by push the hand tool into the clip area. The clip member will clip on the hand tool when the hand tool was located into the clip area as showing in FIG. 2 and FIG. 3. Owing to the illumination member pivots on the stand wall of the clip assembly, the illumination can be rotated opposite to the clip assembly easily to match the demand of the user. The way the illumination member pivots on the stand wall could be varied. The illumination can be pivoted on the clip assembly by using a single axle or a ball-and-socket joint or other similar structures.

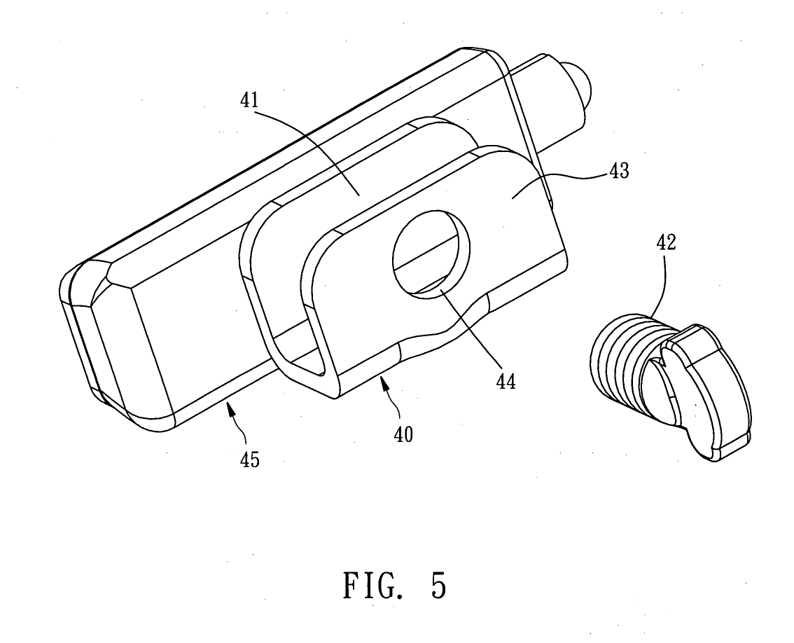

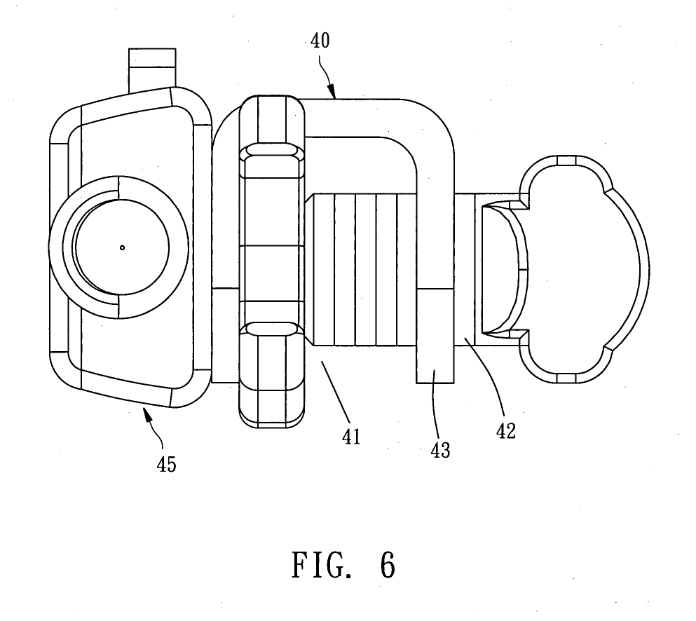

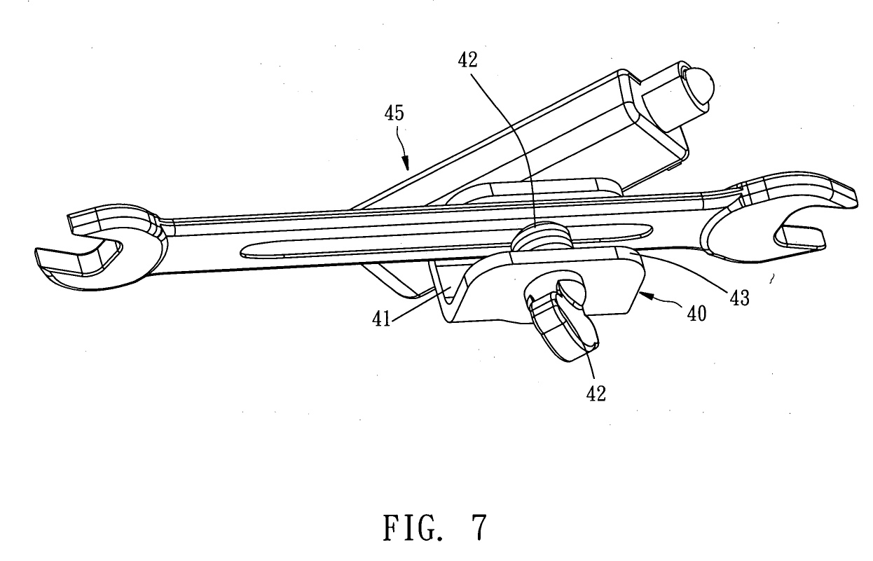

As FIG. 5 to FIG. 7 showing, this is the second embodiment of present invention. The structures in the second embodiment are almost the same with the first embodiment. The illumination member 45 also pivots on the clip assembly. But in the second embodiment, there is no magnet on the clip assembly 40. One of the stand walls has a hole 44 with the thread of a screw and the clip member is a bolt 42. The clip member can be screwed through the hole. Owing to the structures of the second embodiment, present invention can be fixed on a hand tool by putting the hand tool into the clip area 41 and clipping by the clip member and a stand wall.

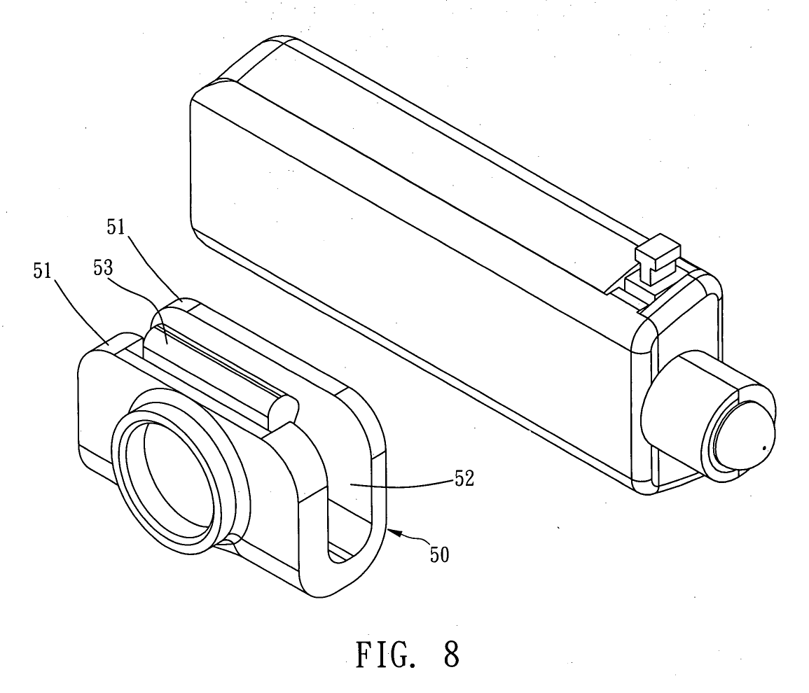

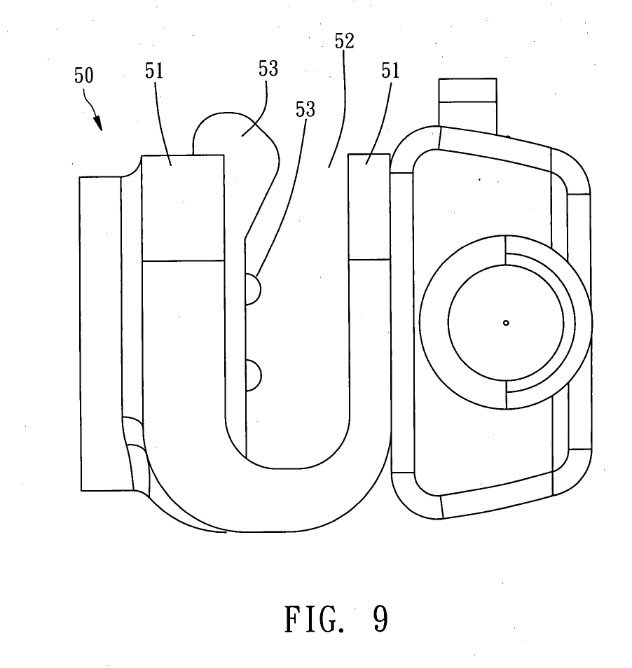

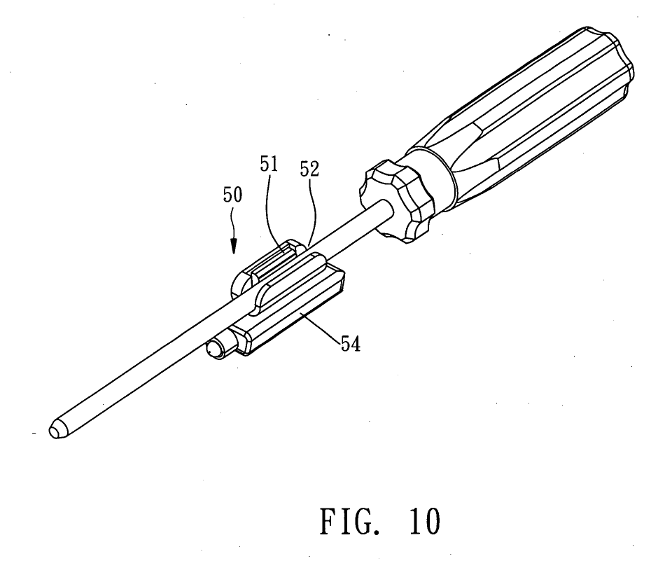

As showing in FIG. 8 to FIG. 10, this is the third embodiment of present invention. There is a clip area 52 on the clip assembly 50 formed by two stand walls 51 also. There are plurality ribs locate on one side of the stand wall formed the clip member 53 in this embodiment. The illumination member 54 pivots on aside of the clip assembly also. As the above-mentioned structures, the hand tool like screwdriver can be pressed into the clip area and clipped by these ribs and opposite stand wall. As FIG. 10 showing, the clip area can add a magnet therein to enhance the stability.

What is claimed is:

1. An auxiliary illumination for hand tools, comprising:
A clip assembly for clip present invention on a hand tool has a clip area, the clip area has a clip member therein and
an illumination member with a shell body pivots on the clip assembly, by the way, the illumination member can be rotated opposite to the clip assembly, and one end of the illumination member has a light and a battery room inside the shell body.

2. The auxiliary illumination for hand tools as defined in claim 1, wherein the clip assembly has a board portion with two fixed stand wall at opposite side and the clip area is therein between these two stand walls.

3. The auxiliary illumination for hand tools as defined in claim 2, wherein the clip member is an elasticity clip board.

4. The auxiliary illumination for hand tools as defined in claim 2, wherein the clip member is a bolt.

5. The auxiliary illumination for hand tools as defined in claim 4, wherein one of the stand walls has a hole with the thread of a screw.

6. The auxiliary illumination for hand tools as defined in claim 2, wherein the clip member was formed by plurality ribs.

7. The auxiliary illumination for hand tools as defined in claim 2, wherein the clip assembly has a magnet.

8. The auxiliary illumination for hand tools as defined in claim 2, wherein the clip member is a spring.

9. The auxiliary illumination for hand tools as defined in claim 2, wherein the clip member is an elastomer.

10. The auxiliary illumination for hand tools as defined in claim 2, wherein the illumination member pivots on a stand wall of the clip assembly.
